(19) United States
(12) Patent Application Publication
(10) Pub. No.: US 2025/0104350 A1
(43) Pub. Date: Mar. 27, 2025

(54) THREE-DIMENSIONAL POINT GENERATION METHOD, THREE-DIMENSIONAL POINT GENERATION DEVICE, DECODING DEVICE, ENCODING DEVICE, DECODING METHOD, AND ENCODING METHOD

(71) Applicant: Panasonic Intellectual Property Corporation of America, Torrance, CA (US)

(72) Inventors: Atsushi ITO, Osaka (JP); Takahiro NISHI, Nara (JP); Toshiyasu SUGIO, Osaka (JP); Noritaka IGUCHI, Osaka (JP)

(21) Appl. No.: 18/975,485

(22) Filed: Dec. 10, 2024

Related U.S. Application Data
(63) Continuation of application No. PCT/JP2023/013861, filed on Apr. 3, 2023.

(30) Foreign Application Priority Data
Jun. 22, 2022 (JP) 2022-100044

(51) Int. Cl. G06T 17/00; G06T 9/00; G06T 19/20

(52) U.S. Cl. CPC G06T 17/00; G06T 9/001; G06T 19/20; G06T 2219/2016

(57) ABSTRACT

A three-dimensional point generation method for generating one or more three-dimensional points in a three-dimensional coordinate system includes: performing at least one of rotation or inversion on one or more second three-dimensional points located in a vicinity of a first three-dimensional point to generate one or more converted second three-dimensional points; and specifying one or more third three-dimensional points associated with the one or more converted second three-dimensional points.

### CROSS REFERENCE TO RELATED APPLICATIONS

This application is a continuation application of PCT International Patent Application No. PCT/JP2023/013861 filed on Apr. 3, 2023 designating the United States of America, which is based on and claims priority of Japanese Patent Application No. 2022-100044 filed on Jun. 22, 2022. The entire disclosures of the above-identified applications, including the specifications, drawings and claims are incorporated herein by reference in their entirety.

### FIELD

The present disclosure relates to a three-dimensional point generation method, a three-dimensional point generation device, a decoding device, an encoding device, a decoding method, and an encoding method.

### BACKGROUND

Techniques for increasing the number of three-dimensional points included in point cloud data (i.e., enhancing resolution) are known (see, for example, Non Patent Literature (NPL) 1).

### CITATION LIST

### Non Patent Literature

NPL 1: BORGES, T. M. (2021), FRACTIONAL SUPER-RESOLUTION OF VOXELIZED POINT CLOUDS [Jun. 21, 2022 search], Internet <URL: https://repositorio.unb.br/bitstream/10482/42300/1/2021_D aviRabbounideCarvalhoFreitas.pdf>

### SUMMARY

A three-dimensional point generation method according to an aspect of the present disclosure is a three-dimensional point generation method for generating one or more three-dimensional points in a three-dimensional coordinate system, the three-dimensional point generation method including: performing at least one of rotation or inversion on one or more second three-dimensional points located in a vicinity of a first three-dimensional point to generate one or more converted second three-dimensional points; and specifying one or more third three-dimensional points associated with the one or more converted second three-dimensional points.

A decoding device according to an aspect of the present disclosure includes: a receiver that receives a bitstream including encoded three-dimensional points; and circuitry that is (i) connected to the receiver and (ii) decodes the encoded three-dimensional points to generate three-dimensional points including a first three-dimensional point and one or more second three-dimensional points located in a vicinity of the first three-dimensional point, wherein the bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

An encoding device according to an aspect of the present disclosure includes: circuitry that encodes three-dimensional points including a first three-dimensional point and one or more second three-dimensional points located in a vicinity of the first three-dimensional point to generate encoded three-dimensional points; and a transmitter that is connected to the circuitry and transmits a bitstream that includes the encoded three-dimensional points, wherein the bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of a three-dimensional data processing device according to Embodiment 1.

FIG. 2 is a diagram illustrating an example of scaling up a point cloud according to Embodiment 1.

FIG. 3 is a flowchart illustrating a process performed by the three-dimensional data processing device according to Embodiment 1.

FIG. 4 is a diagram schematically illustrating the process performed by the three-dimensional data processing device according to Embodiment 1.

FIG. 5 is a diagram illustrating an example of a scale-up pattern list according to Embodiment 1.

FIG. 6 is a diagram illustrating an example of an input point cloud before scale-down, and a point and its neighborhood coordinates after scale-down, according to Embodiment 1.

FIG. 7 is a flowchart of this scale-up processing according to Embodiment 1.

FIG. 8 is a diagram illustrating an example of points before and after scale-up according to Embodiment 1.

FIG. 9 is a diagram schematically illustrating conversion and scale-up processing according to Embodiment 1.

FIG. 10 is a diagram illustrating other examples of neighborhood coordinates used for a neighborhood pattern according to Embodiment 1.

FIG. 11 is a diagram illustrating other examples of neighborhood coordinates used for a neighborhood pattern according to Embodiment 1.

FIG. 12 is a block diagram of an encoding device and a decoding device according to Embodiment 2.

FIG. 13 is a flowchart of an encoding process performed by the encoding device according to Embodiment 2.

FIG. 14 is a diagram schematically illustrating the encoding process according to Embodiment 2.

FIG. 15 is a diagram illustrating an exemplary syntax of scale-up pattern information according to Embodiment 2.

FIG. 16 is a flowchart of a decoding process performed by the decoding device according to Embodiment 2.

FIG. 17 is a diagram schematically illustrating the decoding process according to Embodiment 2.

FIG. 18 is a diagram illustrating a first variation of the exemplary syntax of scale-up pattern information according to Embodiment 2.

FIG. 19 is a diagram illustrating an exemplary syntax of a grouping table according to Embodiment 2.

FIG. 20 is a diagram illustrating an example of the grouping table according to Embodiment 2.

FIG. 21 is a diagram illustrating an exemplary syntax of a group scale-up table according to Embodiment 2.

FIG. 22 is a diagram illustrating an example of the group scale-up table according to Embodiment 2.

FIG. 23 is a diagram illustrating a second variation of the exemplary syntax of scale-up pattern information according to Embodiment 2.

FIG. 24 is a diagram illustrating an exemplary syntax of region division information according to Embodiment 2.

FIG. 25 is a flowchart of a three-dimensional point generation process according to the embodiments.

FIG. 26 is a flowchart of a decoding process according the embodiments.

FIG. 27 is a flowchart of an encoding process according to the embodiments.

### DESCRIPTION OF EMBODIMENTS

In conventional techniques, in order to enhance resolution of a three-dimensional point, one or more three-dimensional points associated with one or more three-dimensional points located in a vicinity of the three-dimensional point are specified. However, when the one or more three-dimensional points associated cannot be specified, three-dimensional points have to be specified at random. As a result, resolution enhancement quality becomes low.

In view of this, a three-dimensional point generation method according to an aspect of the present disclosure is a three-dimensional point generation method for generating one or more three-dimensional points in a three-dimensional coordinate system. The three-dimensional point generation method includes: performing at least one of rotation or inversion on one or more second three-dimensional points located in a vicinity of a first three-dimensional point to generate one or more converted second three-dimensional points; and specifying one or more third three-dimensional points associated with the one or more converted second three-dimensional points.

The specified third three-dimensional points are used, for example, as three-dimensional points obtained by enhancing resolution of the first three-dimensional point, or as three-dimensional points for generating the three-dimensional by enhancing resolution of the first points obtained three-dimensional point. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, the three-dimensional point generation method can, for example, reduce the occurrence of cases in which one or more third three-dimensional points for use in resolution enhancement cannot be specified, thereby improving the quality of resolution enhancement.

For example, in the specifying, a lookup table may be referenced in order to specify the one or more third three-dimensional points, and the lookup table may associate first candidates of the one or more third three-dimensional points with second candidates of the one or more second three-dimensional points and the one or more converted second three-dimensional points.

For example, a first candidate associated with a second candidate may be specified, the second candidate being similar but not identical to actual points of the one or more second three-dimensional points.

Accordingly, the three-dimensional point generation method can further reduce the occurrence of cases in which one or more third three-dimensional points cannot be specified.

For example, the rotation may include rotating the one or more second three-dimensional points about a Y-axis substantially parallel to a vertical direction in a real world.

When an object symmetrical with respect to the vertical direction, such as a building, is represented by three-dimensional points, the distributions of the three-dimensional points tend to show similarities with respect to axes parallel to the vertical direction. Accordingly, in the above manner, the three-dimensional point generation method can efficiently specify one or more third three-dimensional points in an object symmetrical with respect to the vertical direction, such as a building.

For example, the three-dimensional point generation method may further include performing inverse-conversion on the one or more third three-dimensional points to generate one or more converted third three-dimensional points, the inverse-conversion being an inverse-conversion of the at least one of rotation or inversion performed on the one or more second three-dimensional points.

Accordingly, the three-dimensional point generation method can generate one or more converted third three-dimensional points that are more suitable for the one or more second three-dimensional points before conversion.

For example, the three-dimensional point generation method may further include estimating one or more fourth three-dimensional points from the one or more second three-dimensional points.

The estimated fourth three-dimensional point is used as a three-dimensional point obtained by enhancing resolution of the first three-dimensional point. Accordingly, compared to when a random point is used, the three-dimensional point generation method can improve resolution enhancement quality by using the fourth three-dimensional point.

For example, the three-dimensional point generation method may further include: performing at least one of rotation or inversion on one or more fifth three-dimensional points located in a vicinity of the first three-dimensional point to generate one or more converted fifth three-dimensional points; and specifying one or more sixth three-dimensional points associated with the one or more converted fifth three-dimensional points. Here, the total number of the one or more fifth three-dimensional points is different from a total number of the one or more second three-dimensional points.

Accordingly, the three-dimensional point generation method can reduce the occurrence of cases in which one or more third three-dimensional points or one or more sixth three-dimensional points cannot be specified.

For example, in the specifying, a first table and a second table may be referenced in order to specify the one or more third three-dimensional points. The one or more second three-dimensional points and the one or more converted second three-dimensional points may be classified into groups. The first table may associate first candidates of the one or more third three-dimensional points with the groups, and the second table may associate the groups with second candidates of the one or more second three-dimensional points and the one or more converted second three-dimensional points.

Accordingly, the three-dimensional point generation method can reduce the combinations of first candidates and second candidates, and thus the data size of a table for specifying one or more third three-dimensional points can be reduced.

A three-dimensional point generation device according to an aspect of the present disclosure is a three-dimensional point generation device that generates one or more three-dimensional points in a three-dimensional coordinate system. The three-dimensional point generation device includes: memory; and circuitry connected to the memory. The circuitry: performs at least one of rotation or inversion on one or more second three-dimensional points located in a vicinity of a first three-dimensional point to generate one or more converted second three-dimensional points; and specifies one or more third three-dimensional points associated with the one or more converted second three-dimensional points.

The specified third three-dimensional points are used, for example, as three-dimensional points obtained by enhancing resolution of the first three-dimensional point, or as three-dimensional points for generating the three-dimensional points obtained by enhancing resolution of the first three-dimensional point. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, the three-dimensional point generation device can, for example, reduce the occurrence of cases in which one or more third three-dimensional points for use in resolution enhancement cannot be specified, thereby improving the quality of resolution enhancement.

A decoding device according to an aspect of the present disclosure includes: a receiver that receives a bitstream including encoded three-dimensional points; and circuitry that is (i) connected to the receiver and (ii) decodes the encoded three-dimensional points to generate three-dimensional points including a first three-dimensional point and one or more second three-dimensional points located in a vicinity of the first three-dimensional point. The bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

Accordingly, the decoding device, for example, can specify the one or more third three-dimensional points associated with the one or more converted second three-dimensional points generated by performing at least one of rotation or inversion on one or more second three-dimensional points, using the first information and the second information. The specified third three-dimensional points are used, for example, as three-dimensional points obtained by enhancing resolution of the first three-dimensional point, or as three-dimensional points for generating the three-dimensional points obtained by enhancing resolution of the first three-dimensional point. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified.

Accordingly, the decoding device can, for example, reduce the occurrence of cases in which one or more third three-dimensional points for use in resolution enhancement cannot be specified, thereby improving the quality of resolution enhancement.

For example, the second information may include a lookup table that associates first candidates of the one or more third three-dimensional points with second candidates of the one or more second three-dimensional points and the one or more converted second three-dimensional points.

For example, the second information may include: lookup tables each of which associate first candidates of the one or more third three-dimensional points with second candidates of the one or more second three-dimensional points and the one or more converted second three-dimensional points; and third information that indicates, for each of regions to which three-dimensional points belong, a lookup table to be used among the lookup tables.

Accordingly, for each of regions to which a three-dimensional point belongs, the decoding device can use a lookup table that is suitable for the region. Therefore, the quality of resolution enhancement can be improved while suppressing an increase in the processing amount in the decoding device.

For example, the second information may include: a first lookup table that associates first candidates of the one or more third three-dimensional points with groups; and a second lookup table that associates the groups with second candidates of the one or more second three-dimensional points and the one or more converted second three-dimensional points.

Accordingly, the decoding device can reduce the combinations of first candidates and second candidates, and thus the data size of the second information can be reduced.

For example, the first information indicates one or more conversion methods that are useable, among conversion methods each including at least one of rotation or inversion.

Accordingly, for example, the conversion method to be used by the decoding device can be designated in the encoding device according to the properties, and so on, of a point cloud. Therefore, the quality of resolution enhancement can be improved while suppressing an increase in the processing amount in the decoding device.

For example, the first information may further indicate priorities of the one or more conversion methods that are useable.

Accordingly, for example, the priorities of conversion methods to be used by the decoding device can be designated in the encoding device. Therefore, the quality of resolution enhancement can be improved while suppressing an increase in the processing amount in the decoding device.

For example, the bitstream may further include fourth information indicating a total number of the one or more second three-dimensional points.

Accordingly, for example, the number of the one or more second three-dimensional points to be used by the decoding device can be designated in the encoding device according to the properties, and so on, of a point cloud. Therefore, the quality of resolution enhancement can be improved while suppressing an increase in the processing amount in the decoding device.

An encoding device according to an aspect of the present disclosure includes: circuitry that encodes three-dimensional points including a first three-dimensional point and one or more second three-dimensional points located in a vicinity of the first three-dimensional point to generate encoded three-dimensional points; and a transmitter that is connected to the circuitry and transmits a bitstream that includes the encoded three-dimensional points. The bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

Accordingly, the decoding device that decodes the bitstream, for example, can specify the one or more third three-dimensional points associated with the one or more converted second three-dimensional points generated by performing at least one of rotation or inversion on one or more second three-dimensional points, using the first information and the second information. The specified third three-dimensional points are used, for example, as three-dimensional points obtained by enhancing resolution of the first three-dimensional point, or as three-dimensional points for generating the three-dimensional points obtained by enhancing resolution of the first three-dimensional point. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, the decoding device can, for example, reduce the occurrence of cases in which one or more third three-dimensional points for use in resolution enhancement cannot be specified, thereby improving the quality of resolution enhancement.

A decoding method according to an aspect of the present disclosure includes: receiving a bitstream including encoded three-dimensional points; and decoding the encoded three-dimensional points to generate three-dimensional points including a first three-dimensional point and one or more second three-dimensional points located in a vicinity of the first three-dimensional point. The bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

Accordingly, the decoding method, for example, can specify the one or more third three-dimensional points associated with the one or more converted second three-dimensional points generated by performing at least one of rotation or inversion on one or more second three-dimensional points, using the first information and the second information. The specified third three-dimensional points are used, for example, as three-dimensional points obtained by enhancing resolution of the first three-dimensional point, or as three-dimensional points for generating the three-dimensional points obtained by enhancing resolution of the first three-dimensional point. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, the decoding method can, for example, reduce the occurrence of cases in which one or more third three-dimensional points for use in resolution enhancement cannot be specified, thereby improving the quality of resolution enhancement.

An encoding method according to an aspect of the present disclosure includes: encoding three-dimensional points including a first three-dimensional point and one or more second three-dimensional points located in a vicinity of the first three-dimensional point to generate encoded three-dimensional points; and transmitting a bitstream that includes the encoded three-dimensional points. The bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

Accordingly, the decoding device that decodes the bitstream, for example, can specify the one or more third three-dimensional points associated with the one or more converted second three-dimensional points generated by performing at least one of rotation or inversion on one or more second three-dimensional points, using the first information and the second information. The specified third three-dimensional points are used, for example, as three-dimensional points obtained by enhancing resolution of the first three-dimensional point, or as three-dimensional points for generating the three-dimensional points obtained by enhancing resolution of the first three-dimensional point. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, the decoding device can, for example, reduce the occurrence of cases in which one or more third three-dimensional points for use in resolution enhancement cannot be specified, thereby improving the quality of resolution enhancement.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment 1

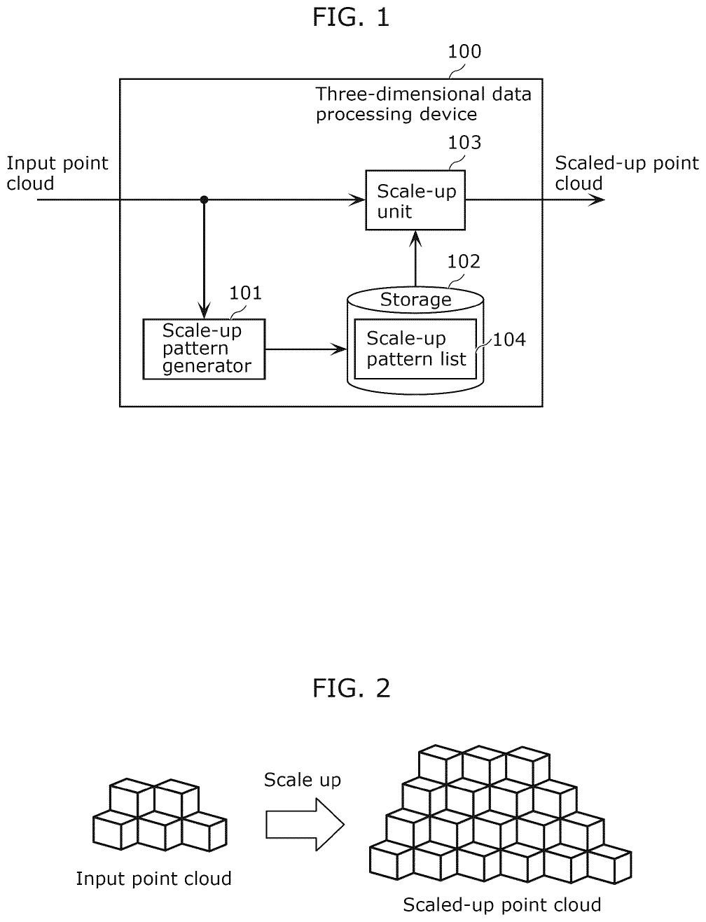

The present embodiment describes a technique of scaling up (enhancing the resolution of) a point cloud that includes multiple three-dimensional points. FIG. 1 is a block diagram illustrating the configuration of three-dimensional data processing device 100 according to the present embodiment. Three-dimensional data processing device 100 (also referred to as a three-dimensional point generation device) scales up input point cloud data to generate scaled-up point cloud data. As illustrated in FIG. 1, three-dimensional data processing device 100 includes scale-up pattern generator 101, storage 102, and scale-up unit 103.

Here, a point (a three-dimensional point) is a minimum unit that constitutes part of a point cloud, and the volume of a point is regarded as zero. A point has a three-dimensional coordinate (three-dimensional position information). A point may further have attribute information, such as color or reflectivity.

Furthermore, scaling up means increasing the resolution (making a voxel grid finer) and increasing the number of points (adding points). A voxel, which is a volume element in a three-dimensional space, is a three-dimensional frame located at each coordinate grid point. Each voxel frame may contain one or more points, or no points. A voxel grid is formed of grid points at coordinates, for example grid points at integer coordinates or power-of-two grid points. Each grid point in a voxel grid has a voxel. It should be noted that scaling up does not necessarily involve an increase in the number of points; the number of points may remain the same.

Furthermore, scaling down means reducing the resolution (making a voxel grid coarser) and reducing the number of points (deleting points). It should be noted that scaling down does not necessarily involve a decrease in the number of points; the number of points may remain the same.

FIG. 2 is a diagram illustrating an example of scaling up a point cloud. As illustrated in FIG. 2, scaling up a point cloud increases the number of voxels. Here, the description illustrates an example in which the size of the point cloud is doubled (doubled in each of the x-, y-, and z-directions), although any other scaling factors may be used. In addition, the description here illustrates a case in which a single voxel corresponds to a single point.

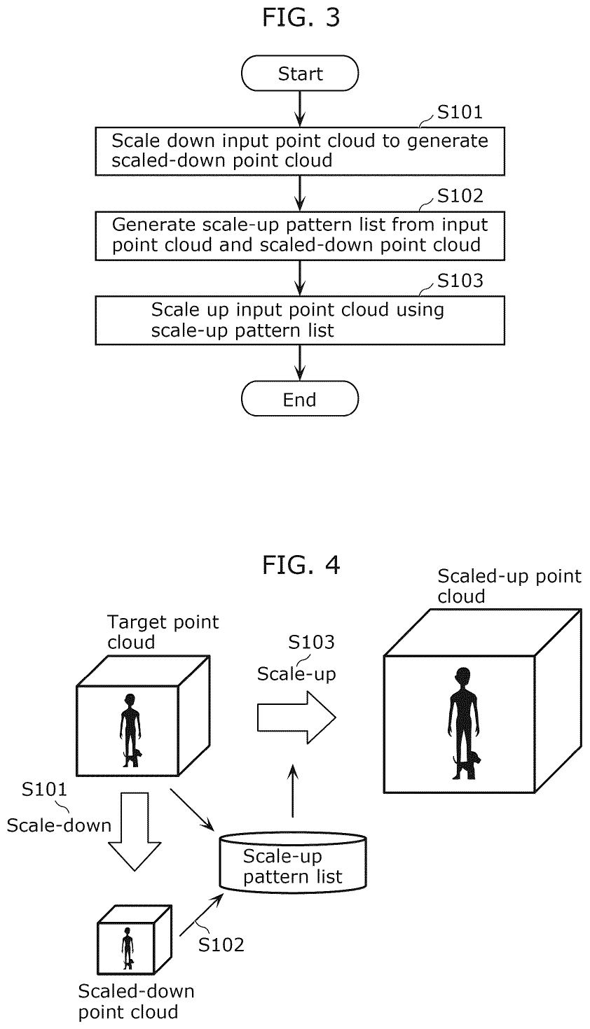

FIG. 3 is a flowchart illustrating a process performed by three-dimensional data processing device 100. Furthermore, FIG. 4 is a diagram schematically illustrating the process performed by three-dimensional data processing device 100.

First, scale-up pattern generator 101 scales down an input point cloud to generate a scaled-down point cloud (S101). For example, scale-up pattern generator 101 generates the scaled-down point cloud by reducing the size of the point cloud by half (reducing by half in each of the x-, y-, and z-directions). It should be noted that the point cloud may be scaled down in any manner. For example, if eight voxels corresponding to a scaled-down voxel contain one or more points, a point may be generated in the scaled-down voxel; otherwise, no point may be generated in the scaled-down voxel. Alternatively, if eight voxels corresponding to a scaled-down voxel contain more than a predetermined number of points, a point may be generated in the scaled-down voxel; otherwise, no point may be generated in the scaled-down voxel.

Next, scale-up pattern generator 101 generates scale-up pattern list 104 using the input point cloud and the scaled-down point cloud (S102). The generated scale-up pattern list 104 is stored in storage 102.

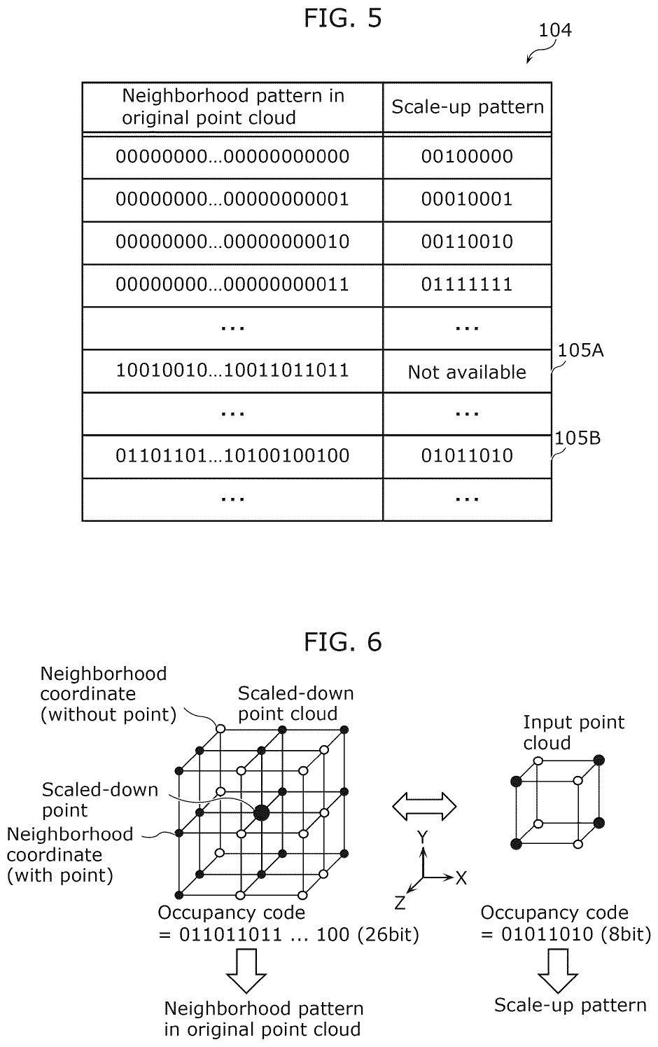

FIG. 5 is a diagram illustrating an example of scale-up pattern list 104. Scale-up pattern list 104 indicates association of neighborhood patterns in an original point cloud with scale-up patterns. For example, scale-up pattern list 104 is a lookup table (LUT) that includes multiple entries. Each entry indicates a neighborhood pattern in the original point cloud, and a scale-up pattern associated with the neighborhood pattern. The neighborhood patterns are an example of second candidates. The scale-up patterns are an example of first candidates. Scale-up pattern list 104 is also called labeled training data for resolution enhancement.

FIG. 6 is a diagram for describing the processing of generating scale-up pattern list 104, illustrating an example of an input point cloud before scale-down, and a point and its neighborhood coordinates after scale-down. For example, as illustrated in FIG. 6, eight points in the input point cloud may be scaled down to one point (a scaled-down point) in a scaled-down point cloud. An occupancy code of the eight points in the input point cloud and an occupancy code of 26 neighborhood coordinates for the scaled-down point are registered in scale-up pattern list 104 as a scale-up pattern and its corresponding neighborhood pattern in the original point cloud, respectively.

It should be noted that, in this registration processing, scale-up patterns are not necessarily registered for all the patterns that may be registered as neighborhood patterns in the original point cloud. Some neighborhood patterns in the original point cloud may have no corresponding scale-up pattern registered.

Also, each bit of an occupancy code corresponds to a coordinate (voxel) and indicates whether the coordinate has a point. For example, the value “1” indicates that the coordinate has a point (is occupied), and the value “0” indicates that the coordinate has no point (is unoccupied).

For example, scale-up pattern generator 101 performs the above processing for each point in the scaled-down point cloud to register scale-up patterns in entries. Thus, scale-up pattern list 104 including multiple registered scale-up patterns is generated. It should be noted that a single neighborhood pattern in the original point cloud may have multiple different scale-up patterns. In that case, scale-up pattern generator 101 may select one scale-up pattern, for example based on the frequency of occurrence, and register the selected scale-up pattern in scale-up pattern list 104.

Here, position information on point clouds is represented using, for example, an N-ary tree structure (N is an integer greater than or equal to two) such as an octree structure. Specifically, in an octree, a target space is divided into eight nodes (subspaces), and 8-bit information (an occupancy code) indicating whether each node includes point clouds is generated. Then, nodes including point clouds are further divided into eight nodes, and 8-bit information indicating whether each of the eight nodes includes point clouds is generated. This processing is repeated up to a predetermined layer or until the number of point clouds included in each node becomes smaller than a threshold.

If point clouds are represented in octree form and the input point cloud is a point cloud of child nodes, it could be said that the scaled-down point cloud of the input point cloud includes parent nodes for the child nodes, and the scaled-down point cloud is a point cloud in a parent-node layer. That is, the occupancy code of eight points serving as child nodes and the occupancy code of 26 neighborhood coordinates for a parent node are registered in scale-up pattern list 104 as a scale-up pattern and its corresponding neighborhood pattern in the original point cloud, respectively.

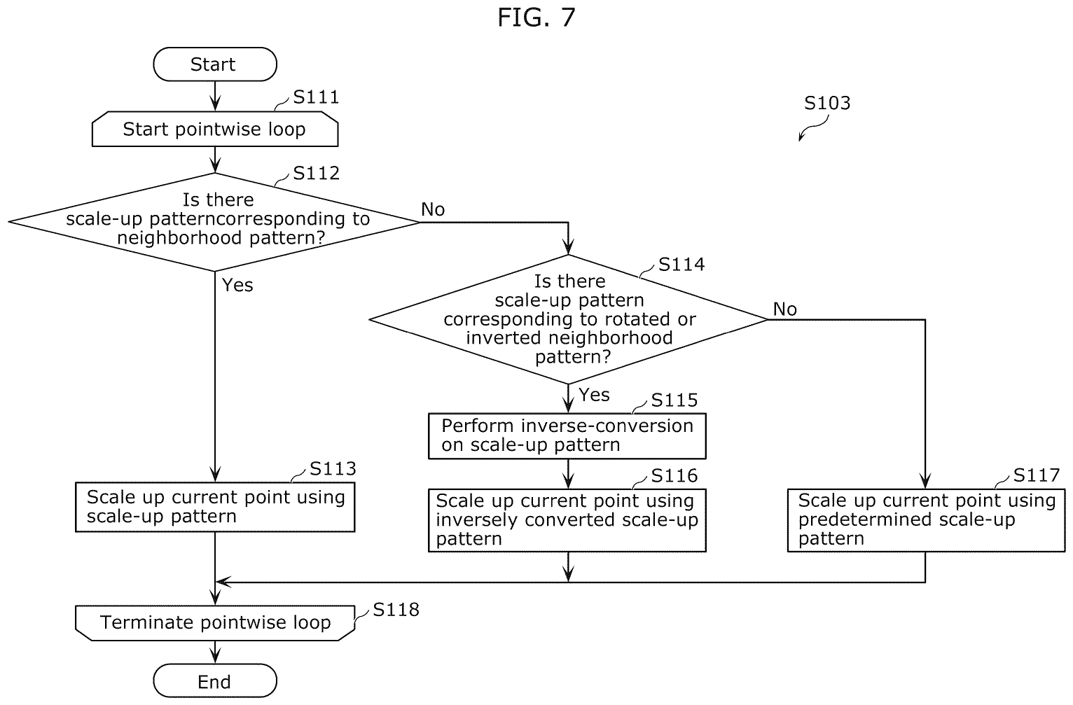

Next, scale-up unit 103 scales up the input point cloud using scale-up pattern list 104 (S103). FIG. 7 is a flowchart of this scale-up processing.

Scale-up unit 103 starts a pointwise loop process for each point in the input point cloud (S111). That is, scale-up unit 103 performs processing at steps S112 to S117 for each point.

First, scale-up unit 103 determines whether a scale-up pattern corresponding to the neighborhood pattern of the current point being processed is registered in scale-up pattern list 104 (S112). If a scale-up pattern corresponding to the neighborhood pattern of the current point is registered in scale-up pattern list 104 (Yes at S112), scale-up unit 103 scales up the current point using the registered scale-up pattern (S113) and terminates the pointwise loop process (S118).

FIG. 8 is a diagram for describing this scale-up processing, illustrating an example of points before and after scale-up. As illustrated in FIG. 8, for example, scale-up unit 103 searches for an entry in which the occupancy code of 26 neighborhood coordinates in the vicinity of the current point is registered as a neighborhood pattern in the original point cloud. According to the occupancy states indicated by the scale-up pattern included in the entry, scale-up unit 103 disposes points at the eight voxels resulting from scale-up. In other words, scale-up unit 103 replaces the voxel of the current point with eight voxels having the occupancy states indicated by the scale-up pattern. Thus, in the example shown in FIG. 8, the single current point is replaced with four points.

In contrast, if no scale-up pattern corresponding to the neighborhood pattern of the current point is registered in scale-up pattern list 104 (No at S112), scale-up unit 103 performs conversion processing, including rotation or inversion, on the neighborhood pattern of the current point; and scale-up unit 103 then determines whether a scale-up pattern corresponding to the converted neighborhood pattern resulting from the conversion is registered in scale-up pattern list 104 (S114).

It should be noted that the current point is an example of a first three-dimensional point, and the one or more points included in the neighborhood pattern are an example of one or more second three-dimensional points. The one or more points included in the converted neighborhood pattern are an example of one or more converted second three-dimensional points. Points included in a pattern are, for example, points corresponding to bits having the value 1 in an occupancy code. Furthermore, the vicinity of the current point refers to a range within a predetermined distance from the current point. In addition, the conversion processing may include performing both of rotation and inversion.

Specifically, scale-up unit 103 selects a conversion method among different conversion methods in a predetermined order, generates a converted neighborhood pattern using the selected conversion method, and determines whether the generated converted neighborhood pattern is registered in scale-up pattern list 104. If the converted neighborhood pattern is not registered in scale-up pattern list 104, scale-up unit 103 uses a next conversion method to generate a converted neighborhood pattern and determines whether the generated converted neighborhood pattern is registered in scale-up pattern list 104. Scale-up unit 103 repeats this processing until scale-up unit 103 finds a converted neighborhood pattern registered in scale-up pattern list 104. Furthermore, if no converted neighborhood pattern generated using any conversion method is registered in scale-up pattern list 104, scale-up unit 103 determines that no scale-up pattern corresponding to the converted neighborhood pattern resulting from the conversion is registered in scale-up pattern list 104 (No at S114).

The conversion methods include, for example, rotation by 90, 180, and 270 degrees about each of the axes (x-axis, y-axis, and z-axis), and inversion in each of the directions of the axes (x-axis, y-axis, and z-axis) (inversion with respect to the yz-plane, xz-plane, and xy-plane).

If a scale-up pattern corresponding to the converted neighborhood pattern is registered in scale-up pattern list 104 (Yes at S114), scale-up unit 103 performs inverse-conversion on the scale-up pattern (S115), scales up the current point using the inversely converted scale-up pattern resulting from the inverse-conversion (S116), and terminates the pointwise loop process (S118).

It should be noted that the one or more points included in the scale-up pattern associated with the converted neighborhood pattern in scale-up pattern list 104 is an example of one or more third three-dimensional points. Furthermore, step S115 may be skipped. That is, the one or more points included in the scale-up pattern may be directly used to generate new three-dimensional points. Thus, skipping the inverse-conversion may have no effect on the quality of the scaled-up point cloud.

If point clouds are represented in octree form and the input point cloud is a point cloud of child nodes, it could be said that the scaled-up point cloud of the input point cloud includes grandchild nodes for the child nodes, and the scaled-up point cloud is a point cloud in a grandchild-node layer.

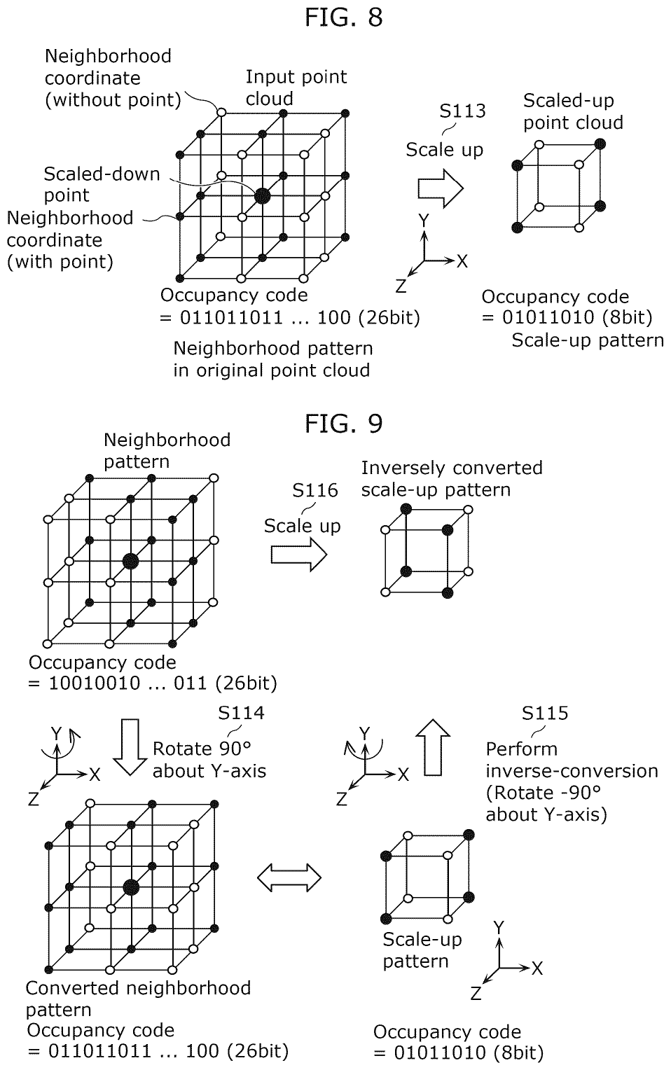

FIG. 9 is a diagram schematically illustrating the above conversion and scale-up processing (S114 to S116). In this example, as illustrated in entry 105A shown in FIG. 5, no scale-up pattern corresponding to the neighborhood pattern illustrated in FIG. 9 is registered in scale-up pattern list 104. In this case, scale-up unit 103 rotates the neighborhood pattern 90 degrees about the Y-axis to generate a converted neighborhood pattern. A scale-up pattern for this converted neighborhood pattern is registered in scale-up pattern list 104, as illustrated in entry 105B shown in FIG. 5.

Next, scale-up unit 103 performs inverse-conversion (rotation by −90 degrees about the Y-axis) on the scale-up pattern to generate an inversely converted scale-up pattern. Lastly, scale-up unit 103 scales up the current point using the inversely converted scale-up pattern.

It should be noted that scale-up unit 103 may also rotate or invert the occupancy code with the following method. For example, for each of the x-, y-, and z-axes and rotation angles (90, 180, and 270 degrees), scale-up unit 103 may logically calculate changes in the bits resulting from rotation or inversion. This can achieve fast processing. Alternatively, scale-up unit 103 may perform rotation or inversion by converting the occupancy code into a point cloud and multiplying the coordinates of the points in the point cloud by a coordinate transformation matrix, and may convert the converted point cloud into an occupancy code. This can facilitate implementation.

Furthermore, if no scale-up pattern corresponding to the converted neighborhood pattern is registered in scale-up pattern list 104 (No at S114), scale-up unit 103 scales up the current point using a predetermined scale-up pattern (S117) and terminates the pointwise loop process (S118). For example, the predetermined scale-up pattern has three-dimensional points disposed at all the eight voxels.

Here, as in step S117, as the frequency of using a scale-up pattern not based on the actual shape of the point cloud increases, the quality of the scaled-up point cloud is more likely to decline. To address this, if no corresponding scale-up pattern is registered, three-dimensional data processing device 100 rotates or inverts the neighborhood pattern and searches for a scale-up pattern associated with the resulting converted neighborhood pattern. Thus, even if the registered scale-up patterns are not many, the registered scale-up patterns can be used to perform appropriate scale-up in more cases. This can improve the quality of the scaled-up point cloud.

It should be noted that the conversion methods used in the conversion at step S114 may be restricted or prioritized based on factors such as geometric information on the input point cloud and meta information that can be estimated. For example, if the input point cloud contains an object symmetrical with respect to the vertical direction, such as a building, rotation about the Y-axis may be given a high priority. Also, if the input point cloud contains a bisymmetrical object such as an automobile or an aircraft, inversion about a particular axis may be given a high priority. This can improve the efficiency of searching the registered scale-up patterns for a similar shape. Furthermore, this can improve the quality of the scaled-up point cloud.

Although the above description illustrates an example in which single scale-up pattern list 104 is generated, multiple scale-up pattern lists 104 may be generated. For example, scale-up pattern list 104 may be generated for each of regions in the point cloud. For example, for a point cloud representing a human shape, scale-up pattern lists may be generated separately for the head and the body. In this case, the scale-up pattern list for the head is used to scale up the point cloud of the head, and the scale-up pattern list for the body is used to scale up the point cloud of the body. Also, each scale-up pattern list is generated using, for example, the target point cloud of the region and its corresponding scaled-down point cloud. This allows the use of a scale-up pattern suitable for the geometric characteristics of each region, thereby improving the quality of the scale-up processing.

Furthermore, three-dimensional data processing device 100 may restrict, or change the priorities of, the conversion methods for each of such regions. For example, whereas rotation and inversion in all the directions may be used for the point cloud of the head, rotation and inversion only in the horizontal direction (about the Y-axis) may be permitted for the point cloud of the body.

If sufficiently many (e.g., more than a predetermined number or percentage of) scale-up patterns are registered in scale-up pattern list 104, scale-up unit 103 may determine that the above processing involving conversion processing (rotation or inversion) (S114 to S116 illustrated in FIG. 7) is unnecessary and may skip the processing. In this case, if no scale-up pattern corresponding to the neighborhood pattern of the current point is registered in scale-up pattern list 104 (No at S112), scale-up unit 103 scales up the current point using a predetermined scale-up pattern (S117). This can reduce the processing amount in three-dimensional data processing device 100.

Although the above description illustrates an example in which scale-up pattern list 104 is generated using the input point cloud and the scaled-down point cloud, scale-up pattern list 104 may be generated in advance. Furthermore, scale-up pattern list 104 may be generated based on multiple input point clouds. For example, if point cloud data on multiple frames representing the same object is input, three-dimensional data processing device 100 may use point clouds for multiple frames to generate scale-up pattern list 104 to be shared by the point clouds for the multiple frames.

Furthermore, in the above description, three-dimensional data processing device 100 determines at steps S112 and S114 whether the neighborhood pattern or converted neighborhood pattern of the current point matches a neighborhood pattern in scale-up pattern list 104. Alternatively, three-dimensional data processing device 100 may determine whether the two neighborhood patterns are similar to each other. For example, if the two occupancy codes indicating the two neighborhood patterns are different only in one bit, the two neighborhood patterns are determined to be similar to each other. It should be noted that, if the two occupancy codes are different in n bits (n is an integer greater than 1), the two neighborhood patterns may be determined to be similar to each other. Furthermore, three-dimensional data processing device 100 scales up the current point using a scale-up pattern (or an inversely converted version thereof) in scale-up pattern list 104 associated with the neighborhood pattern determined to be similar.

For example, three-dimensional data processing device 100 may perform the above similarity determination if no corresponding scale-up pattern is found in both the regular search processing (S112) and the search processing involving conversion processing (S114) (No at S114). For example, in this similarity determination, three-dimensional data processing device 100 may perform the similarity determination on the normal neighborhood pattern not subjected to conversion processing and, if no corresponding scale-up pattern is found, further perform the similarity determination on a converted neighborhood pattern. Alternatively, if no corresponding scale-up pattern is found in the regular search processing (S112) (No at S112), three-dimensional data processing device 100 may perform the similarity determination on the normal neighborhood pattern; then, if no corresponding scale-up pattern is found in the similarity determination, perform the search processing involving conversion processing (S114) and perform the similarity determination on a converted neighborhood pattern.

Furthermore, in the above description, three-dimensional data processing device 100 performs the conversion processing (S114) during the determination processing on each point. Alternatively, the number of scale-up patterns in scale-up pattern list 104 may be increased in advance by performing conversion processing (rotation or inversion) on the neighborhood patterns and scale-up patterns in the entries registered in scale-up pattern list 104. This eliminates the need for the above processing at steps S114 to S116 and enables search involving rotation and inversion to be performed in the determination processing at step S112.

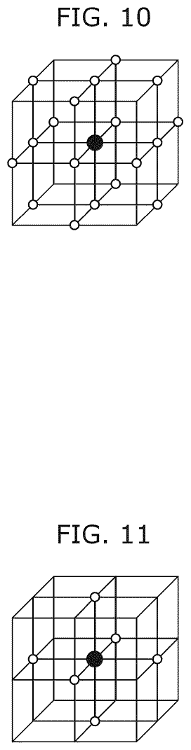

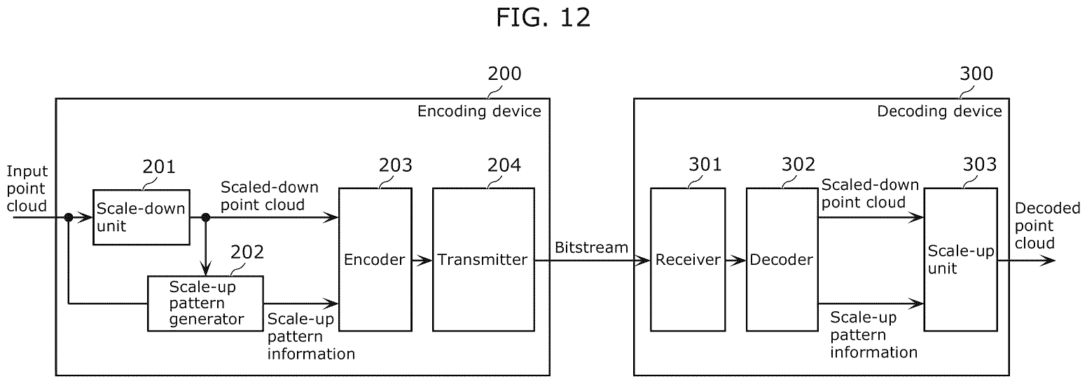

Furthermore, the above description illustrates an example of using the neighborhood pattern of 26 neighborhood coordinates in the vicinity of the current point, as illustrated in diagrams such as FIG. 8. However, the neighborhood pattern is not limited to this form. FIGS. 10 and 11 are diagrams illustrating other examples of neighborhood coordinates used for the neighborhood pattern. For example, as illustrated in FIG. 10, the occupancy states of 18 neighborhood coordinates in the vicinity of the current point may be used as the neighborhood pattern. Alternatively, as illustrated in FIG. 11, the occupancy states of 6 neighborhood coordinates in the vicinity of the current point may be used as the neighborhood pattern.

Furthermore, the scale-up pattern list may be generated for each of the above neighborhood pattern of 26 neighborhood coordinates, neighborhood pattern of 18 neighborhood coordinates, and neighborhood pattern of 6 neighborhood coordinates. Here, generally, as the number of neighborhood coordinates used for the neighborhood pattern increases, the geometric accuracy provided by the scale-up pattern increases. Therefore, for example, at step S112 in FIG. 7, three-dimensional data processing device 100 may perform search by sequentially using the neighborhood pattern of 26 neighborhood coordinates, the neighborhood pattern of 18 neighborhood coordinates, and the neighborhood pattern of 6 neighborhood coordinates. If no corresponding scale-up pattern is found for any of these neighborhood patterns, the search processing involving conversion processing (S114) may be performed. Then, in the search processing involving conversion processing (S114), three-dimensional data processing device 100 may perform search by sequentially using the neighborhood pattern of 26 neighborhood coordinates, the neighborhood pattern of 18 neighborhood coordinates, and the neighborhood pattern of 6 neighborhood coordinates. This can reduce the frequency of performing the search processing involving conversion processing (S114), thereby reducing the processing load. In this example, the one or more points included in the neighborhood pattern of 26 neighborhood coordinates correspond to the one or more second three-dimensional points, and the one or more points included in the neighborhood pattern of 18 neighborhood coordinates or the neighborhood pattern of 6 neighborhood coordinates correspond to fifth three-dimensional points. However, the second three-dimensional points and the fifth three-dimensional points are not limited to these examples and may correspond to mutually different numbers of neighborhood coordinates.

Alternatively, three-dimensional data processing device 100 may perform the regular search processing (S112) and the search processing involving conversion processing (S114) using the neighborhood pattern of 26 neighborhood coordinates. If no corresponding scale-up pattern is found in both steps, three-dimensional data processing device 100 may perform the regular search processing (S112) and the search processing involving conversion processing (S114) using the neighborhood pattern of 18 neighborhood coordinates. Then, three-dimensional data processing device 100 may perform the regular search processing (S112) and the search processing involving conversion processing (S114) using the neighborhood pattern of 18 neighborhood coordinates. If no corresponding scale-up pattern is found in both steps, three-dimensional data processing device 100 may perform the regular search processing (S112) and the search processing involving conversion processing (S114) using the neighborhood pattern of 6 neighborhood coordinates. In this manner, the neighborhood pattern of 26 neighborhood coordinates can be given a high priority, leading to improved quality of the scaled-up point cloud.

Furthermore, the range of neighborhood coordinates used as the neighborhood pattern is not limited to a cube as illustrated in diagrams such as FIG. 8, and may also be a rectangular parallelepiped or an ellipsoid. Furthermore, any range of neighborhood coordinates may be used as the neighborhood pattern. For example, the occupancy code of coordinates that fall within two or three voxels from the current point in a particular direction, such as the horizontal direction, may be used as the neighborhood pattern.

Furthermore, in the example illustrated in FIG. 7, three-dimensional data processing device 100 uses a predetermined scale-up pattern if the scale-up pattern list 104 does not include the corresponding scale-up pattern (e.g., No at S114). Instead of this, the following processing may be performed.

For example, three-dimensional data processing device 100 may use the occupancy states of coordinates in the vicinity of the current point to estimate a point distribution that would result from scale-up. For example, three-dimensional data processing device 100 applies a filter to the occupancy states of coordinates in the vicinity of the current point to calculate the occurrence probabilities of interpolation coordinates, and compares the occurrence probabilities with a threshold to determine whether each voxel after scale-up has a point. Another method that may be used by three-dimensional data processing device 100 involves estimating the surface shape of the object from the point distribution state around the current point and generating points around the estimated shape. The points generated by the estimation are an example of one or more fourth three-dimensional points.

### Embodiment 2

The present embodiment describes a point cloud encoding (compression) method to which the above-described point cloud scale-up processing is applied. FIG. 12 is a block diagram of encoding device 200 and decoding device 300 according to the present embodiment.

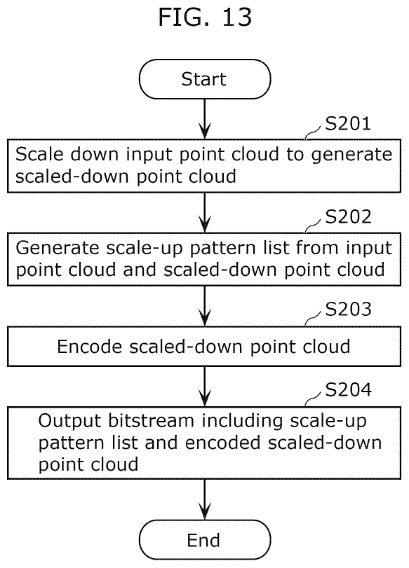

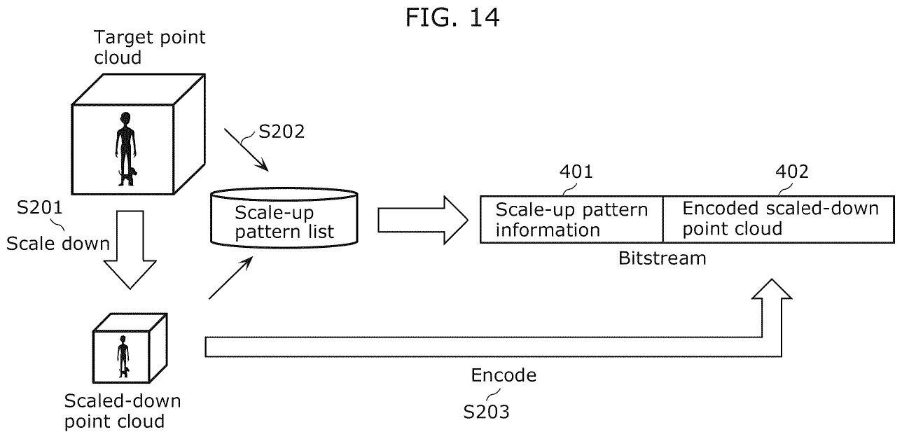

Encoding device 200 encodes an input point cloud to generate a bitstream. Encoding device 200 includes scale-down unit 201, scale-up pattern generator 202, encoder 203, and transmitter 204. FIG. 13 is a flowchart of an encoding process performed by encoding device 200. FIG. 14 is a diagram schematically illustrating the encoding process.

First, scale-down unit 201 scales down an input point cloud to generate a scaled-down point cloud (S201). Next, scale-up pattern generator 202 generates a scale-up pattern list from the input point cloud and the scaled-down point cloud (S202). It should be noted that the details of these processing steps are the same as those of the above-described processing by scale-up pattern generator 101 in three-dimensional data processing device 100.

Next, encoder 203 encodes the scaled-down point cloud to generate an encoded scaled-down point cloud (S203). This encoding processing can use a known point cloud encoding (point cloud compression) technique. For example, this encoding processing includes quantization processing, intra-prediction processing, inter-prediction processing, and arithmetic encoding processing. Furthermore, encoder 203 generates a bitstream that includes the following items: scale-up pattern information 401 indicating the scale-up pattern list; and encoded scaled-down point cloud 402. It should be noted that encoder 203 may encode (e.g., arithmetically encode) the scale-up pattern information before storing it in the bitstream.

It should be noted that, if point clouds are represented in octree form, it could be said that scaling down the input point cloud and encoding the scaled-down point cloud means not encoding nodes below a predetermined level in the octree of the input point cloud. Also, it could be said that scale-up pattern information 401 (the scale-up pattern list) is information for decoding device 300 to reproduce the nodes below the predetermined level.

Next, transmitter 204 transmits the generated bitstream to decoding device 300 (S204).

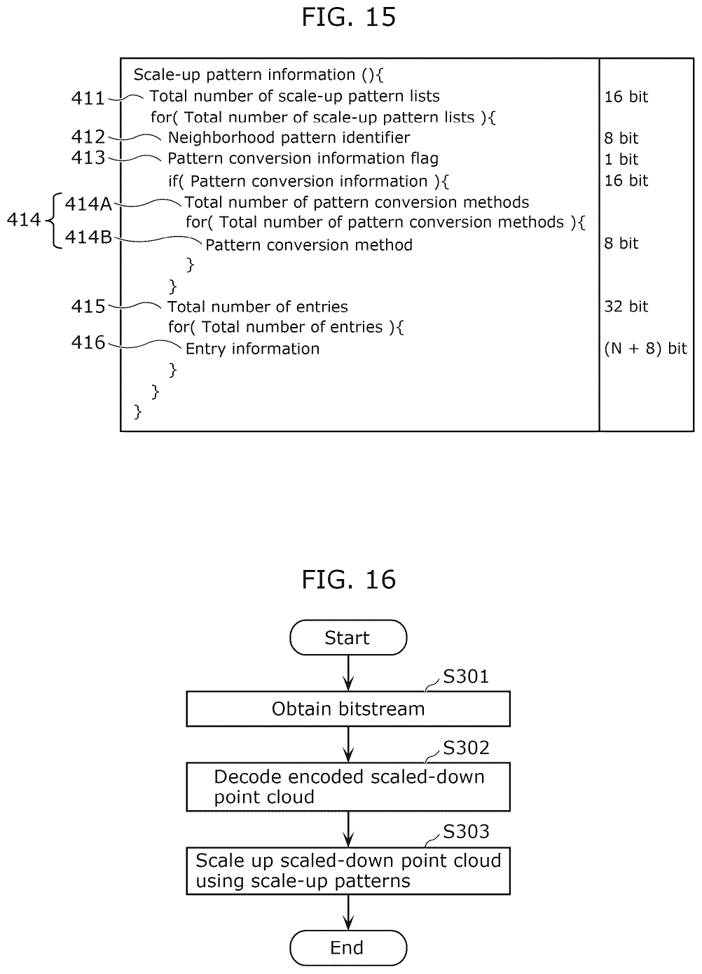

FIG. 15 is a diagram illustrating an exemplary syntax of scale-up pattern information 401. Scale-up pattern information 401 includes total number of scale-up pattern lists 411. It should be noted that the number of bits (the bit length) of each signal shown in FIG. 15 and in the diagrams illustrating exemplary syntaxes to be described below is merely exemplary, and the number of bits of each signal is not limited to these examples.

Total number of scale-up pattern lists 411 indicates the number of scale-up pattern lists included in scale-up pattern information 401. It should be noted that each scale-up pattern list has a configuration similar to that of scale-up pattern list 104 described in Embodiment 1. Scale-up pattern information 401 further includes, for each scale-up pattern list, neighborhood pattern identifier 412 and pattern conversion information flag 413.

Neighborhood pattern identifier 412 indicates the range of neighborhood coordinates used as the neighborhood pattern of the current point. For example, the value 0 indicates that 6 neighborhood coordinates in a cube (e.g., FIG. 11) are used, the value 1 indicates that 18 neighborhood coordinates in a cube (e.g., FIG. 10) are used, the value 2 indicates that 26 neighborhood coordinates in a cube (e.g., FIG. 8) are used, the value 3 indicates that neighborhood coordinates in an ellipsoid are used, and the value 4 indicates that neighborhood coordinates in a rectangular parallelepiped are used. It should be noted that the values and the neighborhood coordinate ranges illustrated above are merely exemplary and not limiting. Furthermore, the value of neighborhood pattern identifier 412 determines the bit length (=N) of the occupancy codes of the neighborhood patterns in the original point cloud included in the scale-up pattern list. For example, N=6 if 6 neighborhood coordinates are used, and N=18 if 18 neighborhood coordinates are used.

Pattern conversion information flag 413 indicates whether pattern conversion information 414 for the corresponding scale-up pattern list is included in scale-up pattern information 401. For example, the value 0 indicates that pattern conversion information 414 is not included in scale-up pattern information 401, and the value 1 indicates that pattern conversion information 414 is included in scale-up pattern information 401.

If pattern conversion information flag 413 indicates that pattern conversion information 414 is included in scale-up pattern information 401 (the value 1), scale-up pattern information 401 includes pattern conversion information 414 as information on each scale-up pattern list. Pattern conversion information 414 includes the following elements: total number of pattern conversion methods 414A; and pattern conversion method 414B as information on each pattern conversion method. Total number of pattern conversion methods 414A indicates the number of pattern conversion methods 414B included in pattern conversion information 414.

Pattern conversion method 414B indicates each conversion method that can be used by decoding device 300. Furthermore, for example, the sequence (the positional order) of the items of pattern conversion method 414B in pattern conversion information 414 indicates the priorities of the conversion methods indicated by pattern conversion method 414B. For example, conversion methods listed higher have higher priorities. The conversion methods include, for example, rotation by 90, 180, and 270 degrees about each of the axes (x-axis, y-axis, and z-axis), and inversion in the each of the directions of the axes (x-axis, y-axis, and z-axis) (inversion with respect to the yz-plane, xz-plane, and xy-plane). In addition, each of pattern conversion methods 414B may include information distinguishing between the exact-match determination and the similarity determination described above.

According to the priorities indicated by pattern conversion information 414, decoding device 300 performs the pattern match determination processing involving conversion processing.

It should be noted that the configuration of pattern conversion information 414 illustrated here is merely exemplary and not limiting. For example, combinations of usable conversion methods and priorities may be predetermined, and pattern conversion information 414 may be an identifier that designates any one of the combinations.

If pattern conversion information flag 413 indicates that pattern conversion information 414 is not included in scale-up pattern information 401 (the value 0), scale-up pattern information 401 does not include pattern conversion information 414. In this case, decoding device 300 does not perform the pattern match determination processing involving conversion processing.

Scale-up pattern information 401 further includes the following elements for each scale-up pattern list: total number of entries 415; and entry information 416 on each entry. Total number of entries 415 indicates the number of entries in the scale-up pattern list. Entry information 416, which is information on each entry in the scale-up pattern list, indicates a neighborhood pattern (an occupancy code) in the original point cloud, and a scale-up pattern (an occupancy code) corresponding to the neighborhood pattern. That is, multiple items of entry information 416 represent scale-up pattern list 104 as illustrated in FIG. 5.

Now, the configuration and operations of decoding device 300 will be described. Decoding device 300 decodes a bitstream generated by encoding device 200 to generate a decoded point cloud. As illustrated in FIG. 12, decoding device 300 includes receiver 301, decoder 302, and scale-up unit 303.

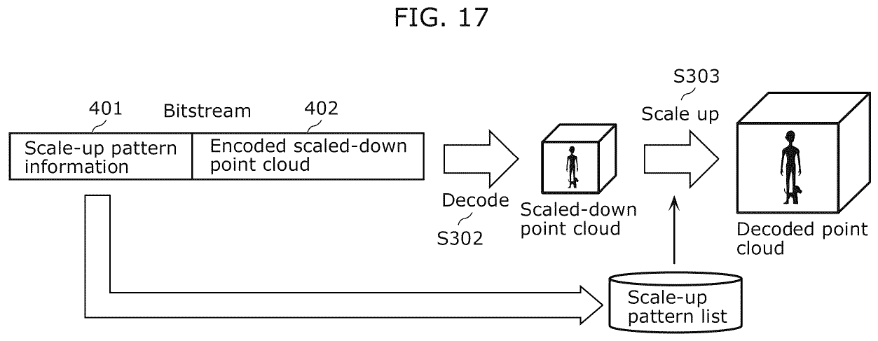

FIG. 16 is a flowchart of a decoding process performed by decoding device 300. FIG. 17 is a diagram schematically illustrating the decoding process.

First, receiver 301 obtains (receives) a bitstream (S301). Next, decoder 302 decodes encoded scaled-down point cloud 402 in the bitstream to generate a scaled-down point cloud (S302). It should be noted that this decoding processing corresponds to the encoding processing performed by encoder 203 and includes, for example, inverse quantization processing, intra-prediction processing, inter-prediction processing, and arithmetic decoding processing.

Next, using scale-up patterns included in a scale-up pattern list indicated by scale-up pattern information 401 in the bitstream, scale-up unit 303 scales up the scaled-down point cloud to generate a decoded point cloud (S303). It should be noted that the details of the scale-up processing are the same as those of the above-described processing by scale-up unit 103 in three-dimensional data processing device 100, except that the input point cloud is replaced with the scaled-down point cloud, and the scaled-up point cloud is replaced with the decoded point cloud.

As above, encoding device 200 generates a bitstream that includes the following items: a scaled-down point cloud (encoded scaled-down point cloud 402) obtained by scaling down an input point cloud; and a scale-up pattern list (scale-up pattern information 401) for scaling up the scaled-down point cloud. Decoding device 300 generates a decoded point cloud corresponding to the input point cloud by scaling up the scaled-down point cloud using the scale-up pattern list.

Here, the data size of the scale-up pattern list is, for example, approximately 1/100 of the data size of the input point cloud. Furthermore, the data size of the point cloud can be significantly reduced (e.g., to approximately ¼ to 1/16) by scaling down the input point cloud to the scaled-down point cloud. Thus, compared to transmitting the input point cloud, the above manner can significantly reduce the data size of the bitstream, thereby reducing the required transmission band.

Furthermore, decoding device 300 performs processing involving conversion processing (rotation or inversion) as in Embodiment 1 (S114 to S116 illustrated in FIG. 7). Thus, even if the registered scale-up patterns are not many, the registered scale-up patterns can be used to perform appropriate scale-up in more cases. This can improve the quality of the scaled-up point cloud.

Before the scale-up pattern list generated from the input point cloud and the scaled-down point cloud is stored in the bitstream, encoding device 200 may delete some entries from the scale-up pattern list. For example, if decoding device 300 is to perform conversion processing, some of the entries including neighborhood patterns that would be converted into identical patterns may be deleted. This can reduce the data size of scale-up pattern information 401.

Also, if decoding device 300 is to perform the above-described similarity determination, some of the entries including neighborhood patterns that would be determined to be similar to each other may be deleted. This can reduce the data size of scale-up pattern information 401.

Furthermore, depending on factors such as the state of the transmission path and the type of the point cloud to be transmitted, encoding device 200 can select the conversion method for the neighborhood pattern and the intensity of the neighborhood pattern (the number of coordinates (the bit length) of the neighborhood pattern) using neighborhood pattern identifier 412 and pattern conversion information 414. Thus, encoding device 200 can designate the conversion method to be used by decoding device 300. This enables decoding device 300 to achieve efficient scale-up pattern search processing and high-quality scale-up processing.

It should be noted that, for successively transmitting multiple point clouds (multiple frames), such as in transmitting video point clouds, encoding device 200 sequentially transmits scale-up pattern information 401 for each point cloud to decoding device 300. Decoding device 300 may accordingly additionally accumulate received scale-up pattern information 401 as needed to perform scale-up processing on the received point clouds using the accumulated multiple items of scale-up pattern information 401. Thus, decoding device 300 can enrich the scale-up pattern list used for the scale-up processing, thereby continuously improving the quality of the scale-up processing. Furthermore, as the scale-up pattern list is enriched, decoding device 300 performs the conversion processing less frequently. This can reduce the processing amount in decoding device 300.

It should be noted that, for transmitting video point clouds, encoding device 200 may transmit, to decoding device 300 in advance, scale-up pattern information 401 corresponding to point clouds for multiple frames. This allows decoding device 300 to perform fast and high-quality scale-up processing from the beginning of the video point cloud. It should be noted that the accumulated scale-up pattern information 401 need not be items of scale-up pattern information 401 belonging to the same video point cloud. For example, the items of scale-up pattern information 401 used may be those for other point clouds of a type identical or similar to the type of the target point cloud, or with attributes identical or similar to the attributes of the target point cloud.

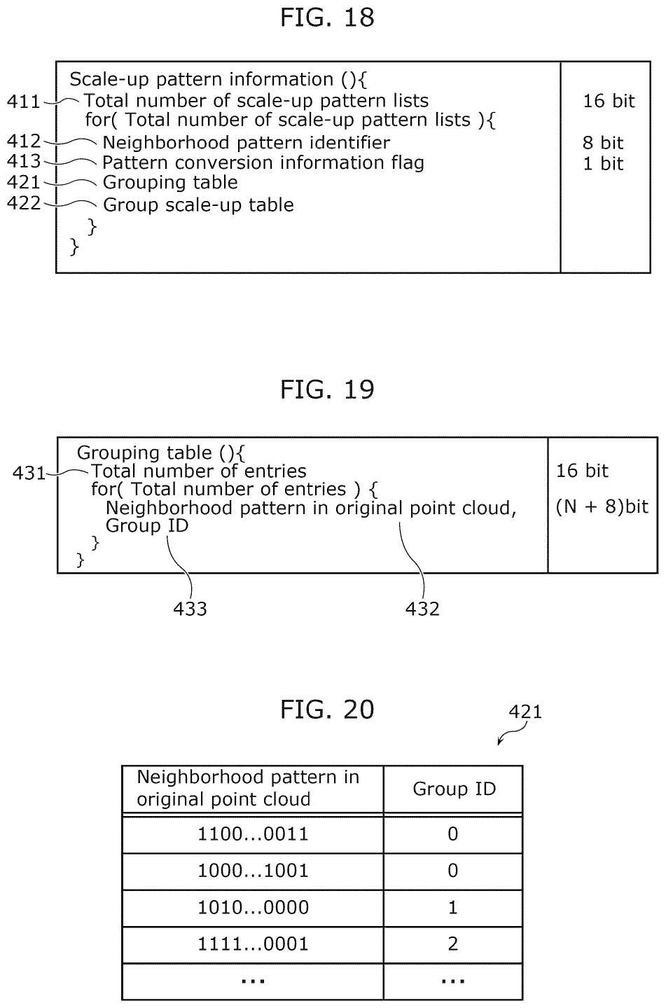

Another exemplary configuration of scale-up pattern information 401 will be described below. FIG. 18 is a diagram illustrating Variation 1 of the exemplary syntax of scale-up pattern information 401. As illustrated in FIG. 18, scale-up pattern information 401 may include, as information on each scale-up pattern list, grouping table 421 and group scale-up table 422. In this example, entry information 416 illustrated in FIG. 15 is defined on a group basis.

FIG. 19 is a diagram illustrating an exemplary syntax of grouping table 421. FIG. 20 is a diagram illustrating an example of grouping table 421.

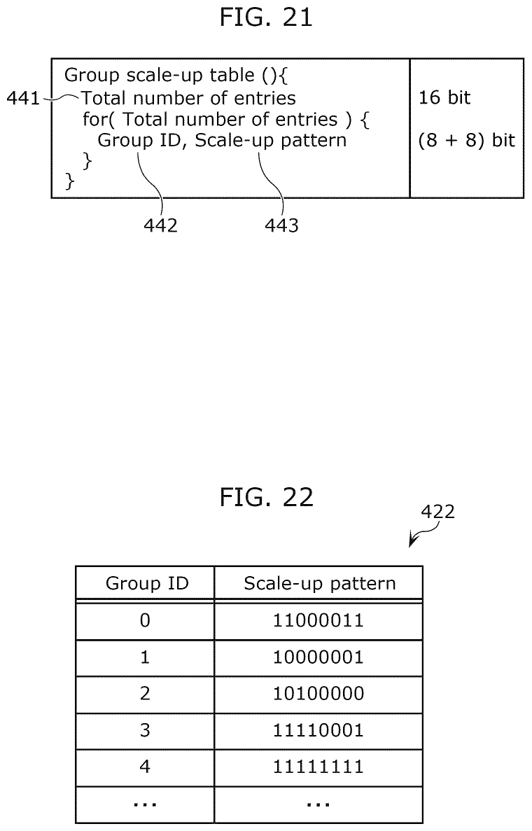

Grouping table 421 includes total number of entries 431 and, for each entry, neighborhood pattern in original point cloud 432 and group ID 433. Total number of entries 431 indicates the number of entries in grouping table 421. Each entry indicates neighborhood pattern in original point cloud 432, and group ID 433 associated with the neighborhood pattern. Here, neighborhood pattern in original point cloud 432 corresponds to a neighborhood pattern in the original point cloud in scale-up pattern list 104 illustrated in FIG. 5. FIG. 21 is a diagram illustrating an exemplary syntax of group scale-up table 422. FIG. 22 is a diagram illustrating an example of group scale-up table 422.

Group scale-up table 422 includes total number of entries 441 and, for each entry, group ID 442 and scale-up pattern 443. Total number of entries 441 indicates the number of entries in group scale-up table 422. Each entry indicates group ID 442, and scale-up pattern 443 associated with the group ID. Here, scale-up pattern 443 corresponds to a scale-up pattern in scale-up pattern list 104 illustrated in FIG. 5.

With the above configuration, decoding device 300 can use grouping table 421 and group scale-up table 422 to associate a neighborhood pattern and a scale-up pattern that have the same group ID in the respective tables to specify the scale-up pattern corresponding to the neighborhood pattern. Furthermore, encoding device 200 can use the group ID to associate multiple neighborhood patterns with a single scale-up pattern. This can achieve processing equivalent to the above-described deletion of some of the entries in the scale-up pattern list (such as deletion of some of the entries including neighborhood patterns that would be converted into identical patterns, or deletion of some of the entries including neighborhood patterns that would be determined to be similar to each other).

It should be noted that the conversion methods indicated by pattern conversion method 414B in the syntax illustrated in FIG. 15 may include the method in Variation 1 (the method using grouping table 421 and group scale-up table 422).

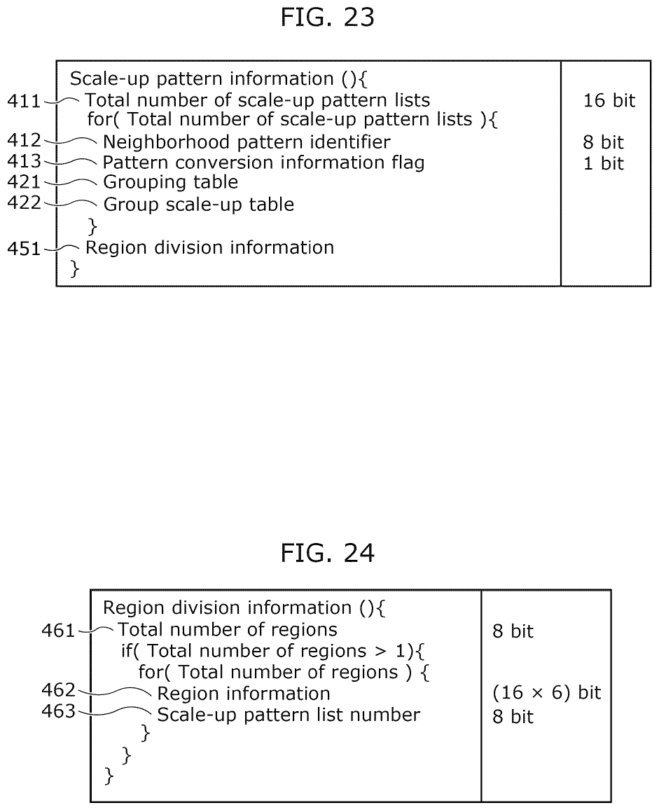

FIG. 23 is a diagram illustrating Variation 2 of the exemplary syntax of scale-up pattern information 401. As illustrated in FIG. 23, scale-up pattern information 401 may further include region division information 451.

FIG. 24 is a diagram illustrating an exemplary syntax of region division information 451. Region division information 451 includes total number of regions 461 and, as information on each region, region information 462 and scale-up pattern list number 463.

Total number of regions 461 indicates the number of three-dimensional regions into which the point cloud is divided. Region information 462 is included in region division information 451 if total number of regions 461 is greater than 1. Region information 462 indicates the range of the region, for example the starting coordinate and the ending coordinate on each of the x-, y-, and z-axes for defining a rectangular parallelepiped in the coordinate area of the point cloud. It should be noted that region information 462 may indicate a reference coordinate for the region (e.g., the center coordinate of a rectangular parallelepiped), and the shape of the region (e.g., the widths along the x-, y-, and z-axes of the rectangular parallelepiped).

Scale-up pattern list number 463 indicates a scale-up pattern list to be used for scale-up processing in the region, among the one or more scale-up pattern lists included in scale-up pattern information 401. For example, scale-up pattern list number 463 indicates the identification numbers of multiple scale-up pattern lists. It should be noted that any other manner of associating the region and the scale-up pattern lists may be used, not limited to the above method.

Here, the regions in the point cloud may have various properties, such as the density, distribution, and nonuniformity of points, and the shape and type of the object. A scale-up pattern list suitable for a region may depend on the properties of the region. Therefore, encoding device 200 selects a scale-up pattern list according to the properties, and instructs decoding device 300 to use the selected scale-up pattern list to scale up the point cloud in the region. This allows decoding device 300 to perform scale-up processing of high quality.

It should be noted that, instead of information designating the scale-up pattern list to be used for each region, encoding device 200 may transmit information indicating the properties of each region to decoding device 300. In this case, decoding device 300 may select, based on the received information indicating the properties of the region, the scale-up pattern list to be used for scale-up processing in the region. Furthermore, decoding device 300 may select a processing method based on a decoded point cloud, the state of the scale-up pattern list, or the states of various resources (such as the CPU load and the available memory space).

Although the above description illustrates an example in which scale-up pattern lists are designated on a region basis, scale-up pattern lists may be designated on a point basis.

Furthermore, information may be transmitted that designates, on a region basis, usable conversion methods or the priorities of the conversion methods.

Although the above description illustrates an example in which a point cloud is scaled up, similar techniques may be applied to other forms of three-dimensional models, such as a mesh model, that include three-dimensional position information. For example, a similar manner may be applied to vertex information included in a mesh model. In this case, for example, information necessary for mesh model formation, such as information indicating connection relationships between vertexes, is transmitted in addition to the vertex information.

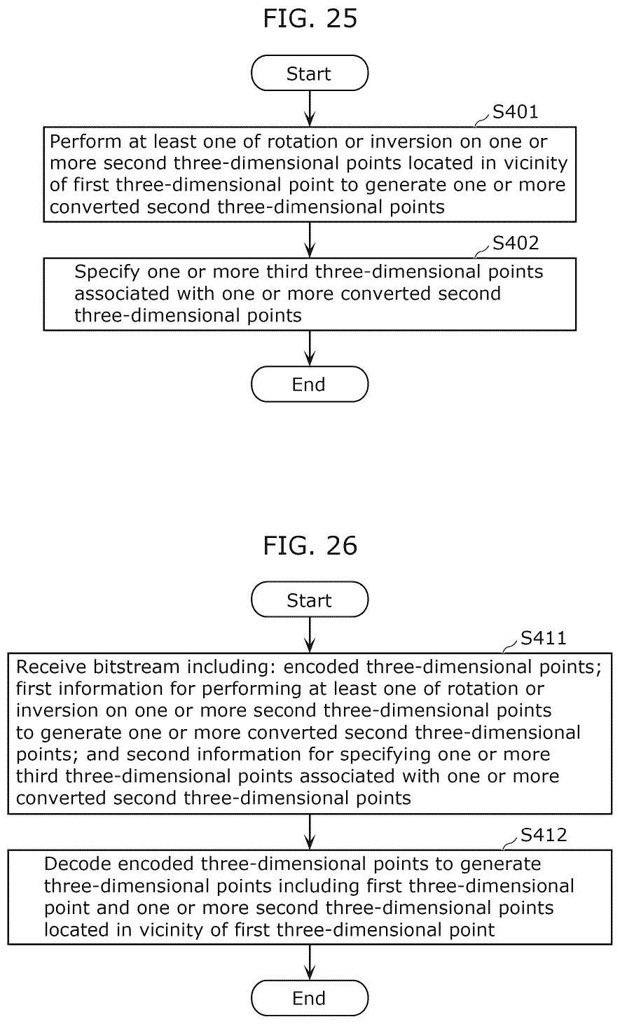

As described above, the three-dimensional point generation device (three-dimensional data processing device) according to the foregoing embodiments performs the process illustrated in FIG. 25. The three-dimensional point generation device generates one or more three-dimensional points in a three-dimensional coordinate system. The three-dimensional point generation device performs at least one of rotation or inversion on one or more second three-dimensional points located in a vicinity of a first three-dimensional point to generate one or more converted second three-dimensional points (S401); and specifies one or more third three-dimensional points associated with the one or more converted second three-dimensional points (S402).

For example, based on the specified one or more third three-dimensional points, the three-dimensional point generation device scales up a point cloud (perform at least one of enhancing the resolution of the point cloud or adding points to the point cloud) by replacing the first three-dimensional point with one or more three-dimensional points (the one or more third three-dimensional points, or one or more three-dimensional points generated based on the one or more third three-dimensional points). That is, the three-dimensional point generation device generates a scaled-up point cloud that includes one or more three-dimensional points (the one or more third three-dimensional points, or one or more three-dimensional points generated based on the one or more third three-dimensional points).

Accordingly, the three-dimensional point generation device can specify the one or more third three-dimensional points associated with the one or more converted second three-dimensional points resulting from performing at least one of rotation or inversion on the one or more second three-dimensional points. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, the three-dimensional point generation device can, for example, reduce the occurrence of cases in which one or more third three-dimensional points for use in resolution enhancement cannot be specified, thereby improving the quality of resolution enhancement.

For example, in the specifying, a lookup table (for example, scale-up pattern list 104) is referenced in order to specify the one or more third three-dimensional points, and the lookup table associates first candidates (for example, the neighborhood patterns in an original point cloud illustrated in FIG. 5) of the one or more third three-dimensional points with second candidates (for example, the scale-up pattern illustrated in FIG. 5) of the one or more second three-dimensional points and the one or more converted second three-dimensional points.

For example, a first candidate associated with a second candidate is specified, the second candidate being similar but not identical to actual points of the one or more second three-dimensional points. Accordingly, the three-dimensional point generation device can further reduce the occurrence of cases in which one or more third three-dimensional points cannot be specified.

For example, the rotation includes rotating the one or more second three-dimensional points about a Y-axis substantially parallel to a vertical direction in a real world. When an object symmetrical with respect to the vertical direction, such as a building, is represented by three-dimensional points, the distributions of the three-dimensional points tend to show similarities with respect to axes parallel to the vertical direction. Accordingly, in the above manner, the three-dimensional point generation device can efficiently specify one or more third three-dimensional points in an object symmetrical with respect to the vertical direction, such as a building.

For example, the three-dimensional point generation device further performs inverse-conversion on the one or more third three-dimensional points to generate one or more converted third three-dimensional points (for example, S115 in FIG. 7), the inverse-conversion being an inverse-conversion of the at least one of rotation or inversion performed on the one or more second three-dimensional points. Accordingly, the three-dimensional point generation device can generate one or more converted third three-dimensional points that are more suitable for the one or more second three-dimensional points before conversion.

For example, the three-dimensional point generation device further estimates one or more fourth three-dimensional points from the one or more second three-dimensional points. The estimated fourth three-dimensional point is used as a three-dimensional point obtained by enhancing resolution of the first three-dimensional point. For example, the three-dimensional point generation device scales up a point cloud by replacing the first three-dimensional point with the one or more fourth three-dimensional points estimated. Furthermore, the three-dimensional point generation device adds the one or more fourth three-dimensional points to the scaled-up point cloud. For example, when one or more third three-dimensional points associated with the one or more converted second three-dimensional cannot be specified, the three-dimensional point generation device may estimate the one or more fourth three-dimensional points from the one or more second three-dimensional points. Accordingly, compared to when a random point is used, the three-dimensional point generation device can improve resolution enhancement quality by using the fourth three-dimensional point.

For example, the three-dimensional point generation device further: performs at least one of rotation or inversion on one or more fifth three-dimensional points (for example, FIG. 10 or FIG. 11) located in a vicinity of the first three-dimensional point to generate one or more converted fifth three-dimensional points; and specifies one or more sixth three-dimensional points associated with the one or more converted fifth three-dimensional points. The total number (for example, 18 or 6) of the one or more fifth three-dimensional points is different from a total number (for example 26) of the one or more second three-dimensional points. Accordingly, the three-dimensional point generation device can reduce the occurrence of cases in which one or more third three-dimensional points or one or more sixth three-dimensional points cannot be specified. For example, the total number (for example, 18 or 6) of the one or more fifth three-dimensional points may be less than the total number (for example 26) of the one or more second three-dimensional points.

For example, in the specifying, a first table (for example, group scale-up table 422) and a second table (for example, grouping table 421) are referenced in order to specify the one or more third three-dimensional points. The one or more second three-dimensional points and the one or more converted second three-dimensional points are classified into groups. The first table associates first candidates (for example, scale-up pattern 443) of the one or more third three-dimensional points with the groups (for example, group ID 442), and the second table associates the groups (for example, group ID 433) with second candidates (for example, neighborhood pattern in original point cloud 432) of the one or more second three-dimensional points and the one or more converted second three-dimensional points. Accordingly, the three-dimensional point generation device can reduce the combinations of first candidates and second candidates, and thus the data size of a table for specifying one or more third three-dimensional points can be reduced.

Furthermore, decoding device 300 according to the present embodiment includes: receiver 301 that receives a bitstream including encoded three-dimensional points; and circuitry (for example, decoder 302 and scale-up unit 303) that is connected to receiver 301 and decodes the encoded three-dimensional points to generate three-dimensional points including a first three-dimensional point and one or more second three-dimensional points located in a vicinity of the first three-dimensional point.

Furthermore, decoding device 300 performs the process illustrated in FIG. 26. Decoding device 300 receives a bitstream including encoded three-dimensional points (S411); and decodes the encoded three-dimensional points to generate three-dimensional points including a first three-dimensional point and one or more second three-dimensional points located in a vicinity of the first three-dimensional point (S412). The bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

For example, decoding device 300 performs, using the first information, at least one of rotation or inversion on the one or more second three-dimensional points to generate one or more converted second three-dimensional points. Decoding device 300 specifies, using the second information, one or more third three-dimensional points associated with the one or more converted second three-dimensional points. Based on the specified one or more third three-dimensional points, decoding device 300 scales up a point cloud (perform at least one of enhancing the resolution of the point cloud or adding points to the point cloud) by replacing the first three-dimensional point with one or more three-dimensional points (the one or more third three-dimensional points, or one or more three-dimensional points generated based on the one or more third three-dimensional points). That is, decoding device 300 generates a scaled-up point cloud that includes one or more three-dimensional points (the one or more third three-dimensional points, or one or more three-dimensional points generated based on the one or more third three-dimensional points).

For example, the first information and the second information are each a signal included in scale-up pattern information 401. For example, the first information and the second information may each be any of the syntax elements illustrated in diagrams such as FIGS. 15, 18, and 23, or may each be any of the signals described as variations of these syntax elements. For example, in the example illustrated in FIG. 15, an example of the first information is pattern conversion information 414, and an example of the second information is entry information 416.

Accordingly, decoding device 300 can specify, using the first information and the second information, one or more third three-dimensional points associated with the one or more converted second three-dimensional points generated by performing at least one of rotation or inversion on the one or more second three-dimensional points. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, decoding device 300 can, for example, reduce the occurrence of cases in which one or more third three-dimensional points for use in resolution enhancement cannot be specified, thereby improving the quality of resolution enhancement.

For example, the second information includes a lookup table (for example, scale-up pattern list (total number of entries 415 and entry information 416)) that associates first candidates of the one or more third three-dimensional points with second candidates of the one or more second three-dimensional points and the one or more converted second three-dimensional points.

For example, the second information includes: lookup tables (for example, scale-up pattern list (total number of entries 415 and entry information 416)) each of which associate first candidates of the one or more third three-dimensional points with second candidates of the one or more second three-dimensional points and the one or more converted second three-dimensional points; and third information (for example, region division information 451) that indicates, for each of regions to which three-dimensional points belong, a lookup table to be used among the lookup tables. Accordingly, for each of regions to which a three-dimensional point belongs, decoding device 300 can use a lookup table that is suitable for the region. Therefore, the quality of resolution enhancement can be improved while suppressing an increase in the processing amount in decoding device 300.

For example, the second information includes: a first lookup table (for example, group scale-up table 422) that associates first candidates (for example, scale-up pattern 443) of the one or more third three-dimensional points with groups (for example, group ID 442); and a second lookup table (for example, grouping table 421) that associates the groups (for example, group ID 433) with second candidates (for example, neighborhood pattern in original point cloud 432) of the one or more second three-dimensional points and the one or more converted second three-dimensional points. Accordingly, decoding device 300 can reduce the combinations of first candidates and second candidates, and thus the data size of the second information can be reduced.

For example, the first information (for example, pattern conversion information 414) indicates one or more conversion methods that are useable, among conversion methods each including at least one of rotation or inversion. Accordingly, for example, the conversion method to be used by decoding device 300 can be designated in encoding device 200 according to the properties, and so on, of a point cloud. Therefore, the quality of resolution enhancement can be improved while suppressing an increase in the processing amount in decoding device 300.

For example, the first information (for example, pattern conversion information 414) further indicates priorities of the one or more conversion methods that are useable. Accordingly, for example, the priorities of conversion methods to be used by decoding device 300 can be designated in encoding device 200. Therefore, the quality of resolution enhancement can be improved while suppressing an increase in the processing amount in decoding device 300.

For example, the bitstream further includes fourth information (for example, neighborhood pattern identifier 412) indicating a total number of the one or more second three-dimensional points. Accordingly, for example, the number of the one or more second three-dimensional points to be used by decoding device 300 can be designated in encoding device 200 according to the properties, and so on, of a point cloud. Therefore, the quality of resolution enhancement can be improved while suppressing an increase in the processing amount in decoding device 300.

Furthermore, encoding device 200 according to the present embodiment includes: circuitry (for example, scale-down unit 201, scale-up pattern generator 202, and encoder 203) that encodes three-dimensional points including a first three-dimensional point and one or more second three-dimensional points located in a vicinity of the first three-dimensional point to generate encoded three-dimensional points; and transmitter 204 that is connected to the circuitry and transmits a bitstream that includes the encoded three-dimensional points.

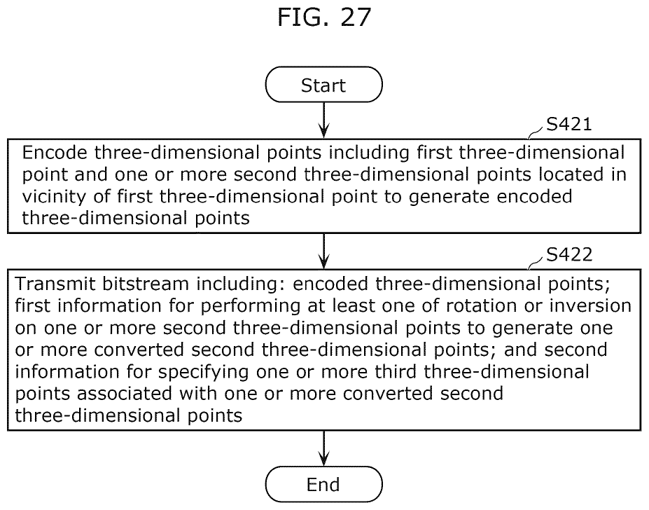

Furthermore, encoding device 200 performs the process illustrated in FIG. 27. Encoding device 200 encodes three-dimensional points including a first three-dimensional point and one or more second three-dimensional points located in a vicinity of the first three-dimensional point to generate encoded three-dimensional points (S421); and transmits a bitstream that includes the encoded three-dimensional points (S422). The bitstream further includes: first information for performing at least one of rotation or inversion of the one or more second three-dimensional points to generate one or more converted second three-dimensional points; and second information for specifying one or more third three-dimensional points associated with the one or more converted second three-dimensional points.

For example, the first information and the second information are each a signal included in scale-up pattern information 401. For example, the first information and the second information may each be any of the syntax elements illustrated in diagrams such as FIGS. 15, 18, and 23, or may each be any of the signals described as variations of these syntax elements.

Accordingly, decoding device 300 that decodes the bitstream, for example, can specify the one or more third three-dimensional points associated with the one or more converted second three-dimensional points generated by performing at least one of rotation or inversion on one or more second three-dimensional points, using the first information and the second information. Accordingly, even in the absence of one or more third three-dimensional points associated with the one or more second three-dimensional points, the one or more third three-dimensional points can still be specified through at least one of rotation or inversion. This can reduce the occurrence of cases in which one or more third three-dimensional points cannot be specified. Accordingly, decoding device 300 can, for example, reduce the occurrence of cases in which one or more third three-dimensional points for use in resolution enhancement cannot be specified, thereby improving the quality of resolution enhancement.

For example, the three-dimensional point generation device, the decoding device, and the encoding device each include a processor and memory, and the processor performs the above processes using the memory. Furthermore, the three-dimensional point generation device, the decoding device, and the encoding device each include circuitry and memory connected to the circuitry, and the circuitry performs the above processes using the memory.

A three-dimensional data processing device, an encoding device, a decoding device, and the like, according to embodiments of the present disclosure and variations of the embodiments have been described above, but the present disclosure is not limited to these embodiments, etc.

Note that each of the processors included in the three-dimensional data processing device, the encoding device, the decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory. The present disclosure may also be implemented as a three-dimensional point generation method, an encoding method, a decoding method, or the like executed by the three-dimensional data processing device, the encoding device, the decoding device, and the like.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

A three-dimensional data processing device, an encoding device, a decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to a three-dimensional data processing device, an encoding device, and a decoding device.

1. A three-dimensional point generation method for generating one or more three-dimensional points in a three-dimensional coordinate system, the three-dimensional point generation method comprising:
performing at least one of rotation or inversion on one or more second three-dimensional points located in a vicinity of a first three-dimensional point to generate one or more converted second three-dimensional points; and
specifying one or more third three-dimensional points associated with the one or more converted second three-dimensional points.

2. The three-dimensional point generation method according to claim 1, wherein
in the specifying, a lookup table is referenced in order to specify the one or more third three-dimensional points, and
the lookup table associates first candidates of the one or more third three-dimensional points with second candidates of the one or more second three-dimensional points and the one or more converted second three-dimensional points.

3. The three-dimensional point generation method according to claim 2, wherein
a first candidate associated with a second candidate is specified, the second candidate being similar but not identical to actual points of the one or more second three-dimensional points.

4. The three-dimensional point generation method according to claim 1, wherein
the rotation includes rotating the one or more second three-dimensional points about a Y-axis substantially parallel to a vertical direction in a real world.

5. The three-dimensional point generation method according to claim 1, further comprising:
performing inverse-conversion on the one or more third three-dimensional points to generate one or more converted third three-dimensional points, the inverse-conversion being an inverse-conversion of the at least one of rotation or inversion performed on the one or more second three-dimensional points.

6. The three-dimensional point generation method according to claim 1, further comprising:
estimating one or more fourth three-dimensional points from the one or more second three-dimensional points.

7. The three-dimensional point generation method according to claim 1, further comprising:
performing at least one of rotation or inversion on one or more fifth three-dimensional points located in a vicinity of the first three-dimensional point to generate one or more converted fifth three-dimensional points; and
specifying one or more sixth three-dimensional points associated with the one or more converted fifth three-dimensional points, wherein
a total number of the one or more fifth three-dimensional points is different from a total number of the one or more second three-dimensional points.

8. The three-dimensional point generation method according to claim 1, wherein
in the specifying, a first table and a second table are referenced in order to specify the one or more third three-dimensional points,
the one or more second three-dimensional points and the one or more converted second three-dimensional points are classified into groups,
the first table associates first candidates of the one or more third three-dimensional points with the groups, and
the second table associates the groups with second candidates of the one or more second three-dimensional points and the one or more converted second three-dimensional points.

9. A three-dimensional point generation device that generates one or more three-dimensional points in a three-dimensional coordinate system, the three-dimensional point generation device comprising:
memory; and
circuitry connected to the memory, wherein
the circuitry:
performs at least one of rotation or inversion on one or more second three-dimensional points located in a vicinity of a first three-dimensional point to generate one or more converted second three-dimensional points; and
specifies one or more third three-dimensional points associated with the one or more converted second three-dimensional points.

10. A decoding device comprising:
a receiver that receives a bitstream including encoded three-dimensional points; and
circuitry that is (i) connected to the receiver and (ii) decodes the encoded three-dimensional points to generate three-dimensional points including a first three-dimensional point and one or more second three-dimensional points located in a vicinity of the first three-dimensional point, wherein
the bitstream further includes:
first information for performing at least one of rotation or inversion of the one or more second three-dimensional points to generate one or more converted second three-dimensional points; and
second information for specifying one or more third three-dimensional points associated with the one or more converted second three-dimensional points.

11. The decoding device according to claim 10, wherein
the second information includes a lookup table that associates first candidates of the one or more third three-dimensional points with second candidates of the one or more second three-dimensional points and the one or more converted second three-dimensional points.

12. The decoding device according to claim 10, wherein
the second information includes:
lookup tables each of which associate first candidates of the one or more third three-dimensional points with second candidates of the one or more second three-dimensional points and the one or more converted second three-dimensional points; and
third information that indicates, for each of regions to which three-dimensional points belong, a lookup table to be used among the lookup tables.

13. The decoding device according to claim 10, wherein
the second information includes:
a first lookup table that associates first candidates of the one or more third three-dimensional points with groups; and
a second lookup table that associates the groups with second candidates of the one or more second three-dimensional points and the one or more converted second three-dimensional points.

14. The decoding device according to claim 10, wherein
the first information indicates one or more conversion methods that are useable, among conversion methods each including at least one of rotation or inversion.

15. The decoding device according to claim 14, wherein
the first information further indicates priorities of the one or more conversion methods that are useable.

16. The decoding device according to claim 10, wherein
the bitstream further includes fourth information indicating a total number of the one or more second three-dimensional points.

17. An encoding device comprising:
circuitry that encodes three-dimensional points including a second first three-dimensional point and one or more three-dimensional points located in a vicinity of the first three-dimensional point to generate encoded three-dimensional points; and
a transmitter that is connected to the circuitry and transmits a bitstream that includes the encoded three-dimensional points, wherein
the bitstream further includes:
first information for performing at least one of rotation or inversion of the one or more second three-dimensional points to generate one or more converted second three-dimensional points; and
second information for specifying one or more third three-dimensional points associated with the one or more converted second three-dimensional points.

18. A decoding method comprising:
receiving a bitstream including encoded three-dimensional points; and
decoding the encoded three-dimensional points to generate three-dimensional points including a first three-dimensional point and one or more second three-dimensional points located in a vicinity of the first three-dimensional point, wherein
the bitstream further includes:
first information for performing at least one of rotation or inversion of the one or more second three-dimensional points to generate one or more converted second three-dimensional points; and
second information for specifying one or more third three-dimensional points associated with the one or more converted second three-dimensional points.

19. An encoding method comprising:
encoding three-dimensional points including a first three-dimensional point and one or more second three-dimensional points located in a vicinity of the first three-dimensional point to generate encoded three-dimensional points; and
transmitting a bitstream that includes the encoded three-dimensional points, wherein
the bitstream further includes:
first information for performing at least one of rotation or inversion of the one or more second three-dimensional points to generate one or more converted second three-dimensional points; and
second information for specifying one or more third three-dimensional points associated with the one or more converted second three-dimensional points.
